(19) United States
(12) Patent Application Publication
(10) Pub. No.: US 2026/0062532 A1
(43) Pub. Date: Mar. 5, 2026

(54) COLORANT REMOVAL FROM POST-CONSUMER POLYETHYLENE TEREPHTHALATE

(71) Applicant: Alliance for Sustainable Energy, LLC, Golden, CO (US)

(72) Inventors: Minjung LEE, Arvada, CO (US); Katrina Marie KNAUER, Denver, CO (US); Robert David ALLEN, Golden, CO (US); Taofeng LU, Lakewood, CO (US)

(21) Appl. No.: 19/313,255

(22) Filed: Aug. 28, 2025

Related U.S. Application Data
(60) Provisional application No. 63/689,939, filed on Sep. 3, 2024.
(60) Provisional application No. 63/720,340, filed on Nov. 14, 2024.

(51) Int. Cl. C08J 11/08

(52) U.S. Cl. CPC C08J 11/08; C08J 2367/02

(57) ABSTRACT

The present disclosure relates to a method that includes dissolving a solid that includes a colorant and polyethylene terephthalate (PET) in 2-isopropylphenol (2-IPP) to form a first mixture and mixing the first mixture with an acetic acid solution to form a second mixture having a solid phase and a liquid phase, where the acetic acid solution includes acetic acid and at least one of water and/or a solvent with the acetic acid present at a concentration between 60 vol % and 100 vol %, inclusively, the solid phase includes at least one of a substantially colorant-free PET or a colorant-free PET, or a combination thereof, and the liquid phase includes acetic acid, 2-IPP, and the colorant.

### CROSS-REFERENCE TO RELATED APPLICATIONS

This application claims priority from U.S. Provisional Patent Application Nos. 63/689,939 and 63/720,340 filed on Sep. 3, 2024 and Nov. 14, 2024, respectively, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Unlike clear polyethylene terephthalate (PET) bottles, colored PET bottles typically include some types of colorants (e.g., chlorinated copper phthalocyanine for green bottles), which often results in undesirable discoloration upon recycling of PET due to the colorants in the recovered PET. The discoloration issue prevents the recycler from reusing PET recovered from bottles, which is estimated to be about 30% of all plastic bottles, of which more than half of PET bottles are colored green. Thus, colored PET bottles are currently subjected to chemical recycling rather than mechanical recycling. There remains, therefore, a need for methods and systems that can remove colorants from recovered PET bottles.

### SUMMARY

An aspect of the present disclosure is a method that includes dissolving a solid that includes a colorant and polyethylene terephthalate (PET) in 2-isopropylphenol (2-IPP) to form a first mixture and mixing the first mixture with an acetic acid solution to form a second mixture having a solid phase and a liquid phase, where the acetic acid solution includes acetic acid and at least one of water and/or a solvent with the acetic acid present at a concentration between 60 vol % and 100 vol %, inclusively, the solid phase includes at least one of a substantially colorant-free PET or a colorant-free PET, or a combination thereof, and the liquid phase includes acetic acid, 2-IPP, and the colorant.

In some embodiments of the present disclosure, the solvent may be present in the acetic acid solution at a concentration between 1 vol % and 40 vol %. In some embodiments of the present disclosure, the solvent may include 2-IPP. In some embodiments of the present disclosure, the liquid phase may further include water. In some embodiments of the present disclosure, during the mixing, the acetic acid solution may result in the second mixture having a volumetric ratio of acetic acid solution to 2-IPP between 1:1 and 10:1. In some embodiments of the present disclosure, the colorant may include at least one of a pigment or a dye or a combination thereof.

In some embodiments of the present disclosure, the dissolving may be performed using a concentration of PET between 1 wt % and 50 wt % PET or between 5 wt % and 10 wt % PET relative to the total mass of the first mixture. In some embodiments of the present disclosure, the solid may further include a contaminant comprising at least one of a metal, a plastic, a plastic additive, an organic contaminant, an inorganic contaminant, or a combination thereof. In some embodiments of the present disclosure, the plastic may include at least one of polyethylene (PE), polypropylene (PP), polyvinyl chloride (PVC), or a combination thereof. In some embodiments of the present disclosure, the metal may include at least one of Al, Ba, Co, Cu, Fe, Li, Mg, Mn, Na, P, Sb, Ge, Ti, Zn, or a combination thereof.

In some embodiments of the present disclosure, the method may further include, after the dissolving and before the mixing, a first treating of the first mixture wherein the treating removes at least a portion of at least one contaminant to form a first intermediate first mixture. In some embodiments of the present disclosure, the contaminant removed may include at least one of dirt, sand, gravel, metal particles, or a combination thereof. In some embodiments of the present disclosure, the first treating may be performed by at least one of gravity settling, filtration, centrifugation, or a combination thereof.

In some embodiments of the present disclosure, the method may further include, after the first treating, a second treating of the first intermediate first mixture, wherein the second treating removes at least a portion of the colorant from the first intermediate first mixture to form a second intermediate first mixture. In some embodiments of the present disclosure, the second treating may be performed by contacting the first intermediate first mixture with an activated carbon.

In some embodiments of the present disclosure, the method may further include, after the second treating, a third treating of the second intermediate first mixture, wherein the second treating removes at least a portion of the metal from the second intermediate first mixture to form a third intermediate first mixture. In some embodiments of the present disclosure, the third treating may be performed by contacting the second intermediate first mixture with an ion exchange resin.

In some embodiments of the present disclosure, the method may further include, after the mixing, a fourth treating of the second mixture, wherein the solid phase is separated from the liquid phase, to yield a substantially pure PET product. In some embodiments of the present disclosure, the fourth treating may be performed by at least one of drying, gravity settling, filtration, centrifugation, or a combination thereof.

### BRIEF DESCRIPTION OF DRAWINGS

Some embodiments are illustrated in referenced figures of the drawings. It is intended that the embodiments and figures disclosed herein are to be considered illustrative rather than limiting.

FIGS. 1A and 1B illustrate an exemplary method for removing colorants from colored polyethylene terephthalate (PET), according to some embodiments of the present disclosure.

FIG. 2 illustrates an embodiment of a system for achieving the method illustrated in FIGS. 1A and 1B, according to some embodiments of the present disclosure.

FIG. 3 illustrates photographs of three different samples of PET derived from bottles that were treated according to the method described above, according to some embodiments of the present disclosure.

FIG. 4 illustrates quantitative measurements of color of each of the three starting PET samples (post-treating, untreated) (green, blue, colorless PET/nylon) as well as “clean” PET versus the same materials after treatment using the methods described herein, according to some embodiments of the present disclosure. Panel A illustrates the metric used to measure color levels. Panel B illustrates photographs of samples treated.

FIG. 5 illustrates ICP-MS results obtained of the precipitated PET solids after the DPR processes for clear PET, green PET, blue PET, and PET/nylon, according to some embodiments of the present disclosure. Units are in ppm.

FIG. 6 illustrates molecular weight data for the three samples illustrated in FIGS. 3-5, according to some embodiments of the present disclosure.

FIGS. 7A, 7B, and 7C illustrate FTIR data that demonstrate the presence of polymeric materials (PE, PP, and nylon) other than PET within the PET bottle samples, according to some embodiments of the present disclosure.

FIGS. 8A-8D illustrate FTIR data that indicate that the purified PET product after the DPR processes contains no PE or PP, according to some embodiments of the present disclosure.

FIG. 9 illustrates solubility data for a system including each of acetic acid, water, and 2-IPP, according to some embodiments of the present disclosure.

To facilitate understanding, identical reference numerals have been used, where possible, to designate identical elements that are common to the figures. It is contemplated that elements and features of one embodiment may be beneficially incorporated in other embodiments without further recitation.

### REFERENCE NUMERALS

100 . . . method
105 . . . solid feed
107 . . . solvent (e.g., 2-IPP)
110 . . . dissolving
115 . . . first mixture
118 . . . precipitant (e.g., acetic acid)
120 . . . mixing
123 . . . second mixture
125 . . . solid phase
127 . . . liquid phase
130 . . . final treating
132 . . . solid product
134 . . . liquid effluent
140 . . . first treating (e.g., filtration)
142 . . . solids
144 . . . first intermediate first mixture
150 . . . second treating (e.g., activated carbon)
154 . . . second intermediate first mixture
160 . . . third treating (e.g., ion-exchange resin)
162 . . . metals
164 . . . third intermediate first mixture

### DETAILED DESCRIPTION

The present disclosure relates to methods and systems for removing colorants from colored polyethylene terephthalate (PET) derived from recovered colored bottles to yield color-free and/or substantially color-free PET that may then be reused and/or combined with originally color-free PET. An aspect of such a method and/or system includes dissolution of the PET and colorant into a solvent, e.g., 2-isopropylphenol (2-IPP), followed by the selective precipitation of the PET achieved by the addition of PET/2-IPP solution into acetic acid, with the colorant remaining dissolved in the liquid phase (acetic acid and 2-IPP). As used herein, the term colorant refers to a pigment or dye that is used to color PET that is initially substantially color-free.

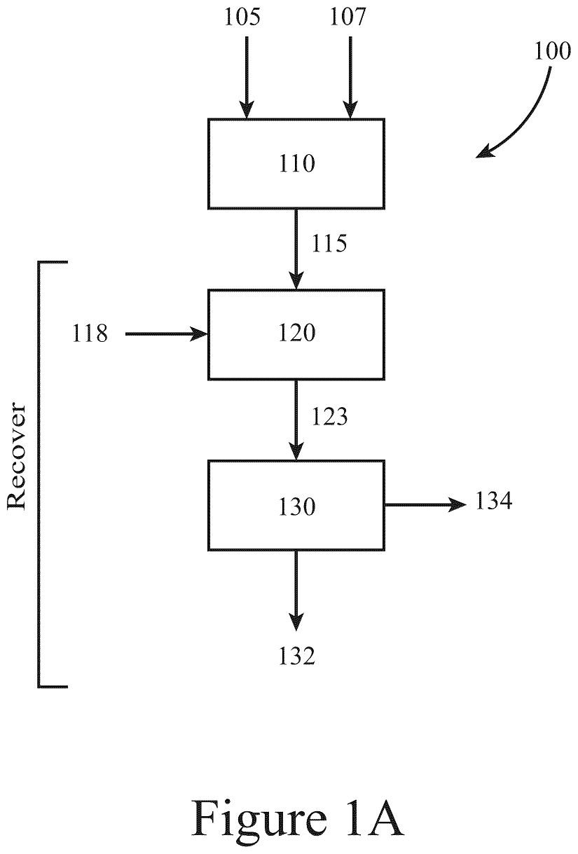

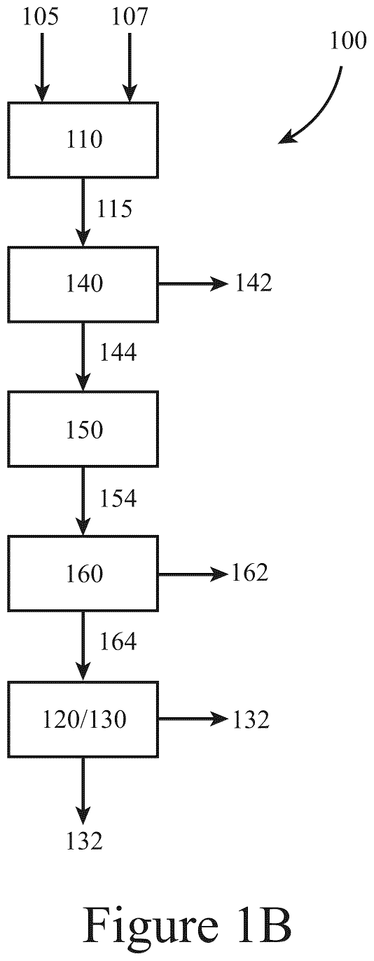

FIGS. 1A and 1B illustrate an exemplary method 100 for removing colorants from colored PET, according to some embodiments of the present disclosure. Referring first to FIG. 1A, a method 100 may begin with the dissolving 110 of a solid feed 105 in a solvent 107. The dissolving 110 results in the colored PET contained in the solid feed 105 to dissolve in the solvent 107, i.e., 2-isopropylphenol (2-IPP), 3-isopropylphenol, 4-isopropylphenol, 4-propylphenol, thymol, guaiacol, 4-ethylguaiacol, 4-propylguaiacol, isoeugenol, ε-caprolactone, eugenol. Both the PET and the colorants used to color the PET dissolve in the solvent, e.g., 2-IPP, resulting in the forming of a first mixture 115. In some embodiments of the present disclosure, a solid feed 105 may be added to a solvent 107 such that the concentration of the PET in the first mixture 115 is between 1 wt % and 50 wt % PET or between 5 wt % and 10 wt % PET, relative to the total mass of the first mixture. In some embodiments of the present disclosure, dissolving 110 may be performed at a temperature between 21° C. and 200° C. or between 100° C. and 160° C. In some embodiments of the present disclosure, dissolving 110 may be performed at about atmospheric pressure. In some embodiments of the present disclosure, dissolving 110 may be performed by contacting the solid feed 105 and the solvent 107 for a period of time between 1 minute and 4 hours or between 10 minutes and 30 minutes.

Referring again to FIG. 1A, once dissolving 110 has resulted in the PET and colorant to go into solution with the solvent 107, the resultant first mixture 115 may be directed to a mixing 120 step, where the first mixture 115 is combined with (e.g., mixed with) a precipitant 118 such as at least one of an acid (e.g., acetic acid, formic acid, propionic acid, oxalic acid, acrylic acid, benzoic acid), a ketone (e.g., acetone), a nitrile (e.g., acetonitrile), and/or an alcohol (e.g., ethanol, methanol). The mixing of the precipitant 118 with the first mixture 115 may result in the selective precipitation of PET from the first mixture 115, thereby forming a second mixture 123 having a solid phase and a liquid phase. The solid phase may include the precipitated PET and potentially other solids that entered with the PET in the solid feed 105. The liquid phase of the second mixture 123 may include solvent 107, precipitant 118, colorant, and any other soluble species that entered with the solid feed 105.

In some embodiments of the present disclosure, a precipitant 118, e.g., acetic acid, may further include water. As shown herein, the concentration of a precipitant 118 in water is a process variable that can be manipulated to control the precipitation of PET from the first mixture 115. In some embodiments of the present disclosure, a precipitant 118 may include acetic acid mixed with water at a concentration of acetic acid between 60 vol % and 100 vol %, inclusively, relative to the total mixture (water plus acetic acid). Further, in some embodiments of the present disclosure, precipitant 118 (e.g., acetic acid), may be added to a first mixture 115 in a mixing 120 step to form a second mixture 123 having a volumetric ratio of precipitant 118 (e.g., acetic acid) to solvent 107 (e.g., 2-IPP) that is between 1:1 and 10:1 (precipitant: solvent).

In some embodiments of the present disclosure, mixing 120 of a precipitant 118 with a first mixture 115 may be performed at temperature between 0° C. and 100° C. or between 0° C. and 50° C. In some embodiments of the present disclosure, mixing 120 may be performed at approximately atmospheric pressure. In some embodiments of the present disclosure, mixing 120 may be performed by contacting the precipitant 118 with the first mixture 115 for a period of time between 1 minute and 4 hours or between 10 minutes and 30 minutes. In some embodiments of the present disclosure, the first mixture 115 may be added to the precipitant 118. In some embodiments of the present disclosure, the precipitant 118 may be added to the first mixture 115.

Referring again to FIG. 1A, with the second mixture 123 containing a solid phase and a liquid phase successfully formed in the mixing 120 step, a method 100 may continue with the removal of the solid, colorless PET from the second mixture 123. The removing of the solid PET is referred to herein as a treating step, a final treating 130, which results in the forming of a solid product 132 containing the targeted color-free PET and a liquid effluent 132 containing solvent 107 and potentially components dissolved in the solvent 107, e.g., colorant. In some embodiments of the present disclosure, a final treating 130 (i.e., removing of solid, colorless PET from a second mixture 123) may be performed using at least one of drying, gravity settling, filtration, and/or centrifugation. An embodiment of filtration that is well suited for this application is vacuum filtration.

Referring again to FIG. 1A, in some embodiments of the present disclosure, a liquid effluent 132 from a final treating 130 step may be directed to down-stream unit operations (not shown) to recover the solvent 107 for recycle to the dissolving 110 step. For example, a liquid effluent 132 containing a solvent 107 and soluble impurities and/or insoluble impurities may be directed to a down-stream distillation column to recover substantially pure solvent for recycle to the dissolving 110 step. In some embodiments of the present disclosure, liquid-liquid extraction may be utilized to recover pure solvent; e.g., the use of water may separate acetic acid contained in a liquid effluent 134 from phenolic compounds contained in the liquid effluent 134.

Furthermore, in some embodiments of the present disclosure, a solid product 132, e.g., colorless PET, may be directed to one or more finishing steps (not shown), for example, a drying step to remove any residual liquid from the solid product 132. In some embodiments of the present disclosure, the solid product 132 (PET) may be subjected to a drying step to obtain a fully dried, colorless step, instead of and/or in addition to a rinsing step. For example, a solid product 132 may be dried at a temperature between 100° C. and 120° C. for a period of time up to 16 hours, or at a temperature between 60° C. and 80° C. for a period of time up to 16 hours. The mixing 120 and final treating 130 steps are referred to herein as the “recovery” steps of the method 100, resulting in the recovery of the targeted solid product 132, color-free PET.

Referring again to FIG. 1A, as described herein, the primary target in a solid feed 105 is colorless PET. However, a solid feed 105 may contain a variety of solid contaminants including other plastics, organic contaminants, and/or inorganic contaminants. Examples of other plastics that may be included in a solid feed 105, in addition to PET, include polyethylene (PE), polypropylene (PP), and/or polyvinyl chloride (PVC). Examples of solid organic contaminants that may be mixed in with PET in a solid feed 105 include food waste and/or dirt. Examples of solid inorganic contaminants that may be mixed in with PET in a solid feed 105 include metal particulates, sand, and/or gravel.

A variety of other contaminants may also enter with PET in a solid feed 105 including plastic additives and soluble metals. Examples of plastic additives include anti-oxidants, thermal stabilizers, nucleating agents, catalysts, processing aids, and/or plasticizers. Soluble metals include Al, Ba, Co, Cu, Fe, Li, Mg, Mn, Na, P, Sb, Ge, Ti, and/or Zn. Thus, a method 100 or system may include one or more treating steps to remove contaminants from the starting solid feed 105 in order to produce a pure final solid product 132, i.e., colorless PET.

Therefore, referring to FIG. 1B, a method 100 may include a number of additional treating steps (140, 150, and 160), referred to herein collectively as “purifying” steps, which result in the forming of intermediate versions of the first mixture 115 exiting the dissolving 110 step, where each successive intermediate mixtures (144, 154, and 164) contains fewer contaminants. For example, as shown in FIG. 1B, a first mixture 115 exiting a dissolving 110 step may be directed to a first treating 140 where insoluble solids are removed from the first mixture 115 forming a substantially solids free first intermediate mixture 144. In some embodiments of the present disclosure, a first treating 140 may include drying, gravity settling, filtration, and/or centrifugation. In some embodiments of the present disclosure, a first treating 140 may be achieved using filtration. In some embodiments of the present disclosure, a first treating 140 may be achieved using a membrane filter having an average pore size of less than or equal to 10 μm. In some embodiments of the present disclosure, a first treating 140 may be achieved using vacuum filtration at a vacuum less than or equal to 100 mbar. Some contaminants that may be removed by a first treating 140 include insoluble plastics, dirt, sand, gravel, and/or metal particles.

Referring again to FIG. 1B, after removal of solid contaminants via a first treating 140 step, the resultant first intermediate mixture 144 may be directed to a second treating 150 designed to target the removal of soluble colorants contained in the first intermediate mixture 144 to form a second intermediate mixture 154 that is colorant-free or substantially colorant-free or removes at least a non-negligible amount of colorant. In some embodiments of the present disclosure, a second treating 150 for removing colorant may be achieved using activated carbon. In some embodiments of the present disclosure, colorant may be removed by directing a first intermediate stream 144 over a fixed-bed packed with a solid adsorbent, e.g., activated carbon. Tests in the laboratory have included testing activated carbon with 20-60 mesh particle size with flow rates between 0.1 ml/min and 0.5 ml/min with a composition of 1 wt % PET in 2-IPP at room temperature. Due to the relatively high viscosity of PET solution in 2-IPP, an activated carbon column (or bed) may require mild heating (40-60° C.) to reduce the viscosity to improve the flow rate. An activated column with a heating jacket may be used.

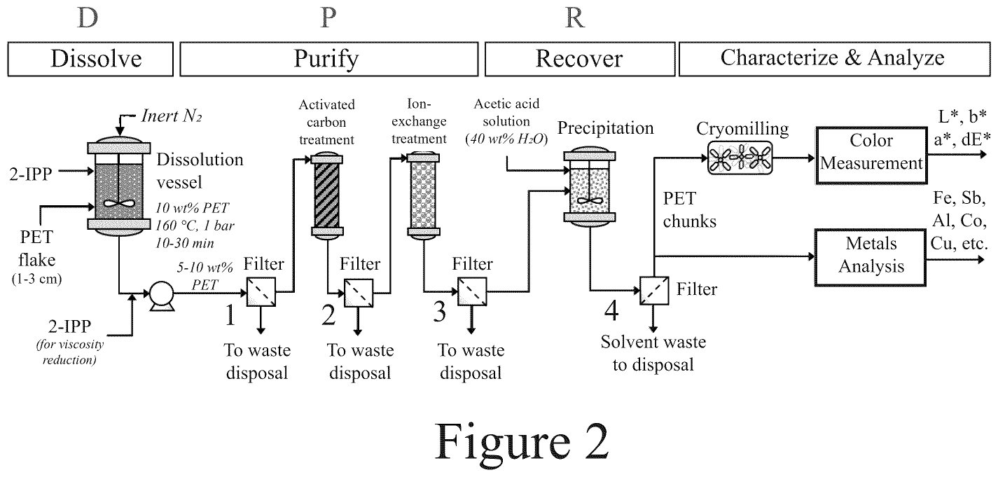

Next, a second intermediate mixture 154 may be directed to a third treating 160 designed for the removal of soluble metals from the second intermediate mixture 154, resulting in the forming of a third intermediate mixture 164 substantially free of metals. In some embodiments of the present disclosure, a third treating 160 for metal removal may be achieved using an ion exchange resin. Metals that may be removed using an ion exchange resin include Al, Ba, Co, Cu, Fe, Li, Mg, Mn, Na, P, Sb, Ge, Ti, and/or Zn. In some embodiments of the present disclosure, soluble metals may be removed in a third treating 160 to levels at or below the detection limits of inductively coupled plasma mass spectroscopy (ICP-MS). In some embodiments of the present disclosure, a soluble metal may be removed by directing a second intermediate stream 154 over a fixed-bed packed with an ion-exchange resin. An exemplary cation exchange resin that was tested is Dowex G20, an exchange resin made of a styrene-divinylbenzene copolymer matrix with sulfonic acid functional groups. Referring again to FIG. 1B, a third intermediate mixture 164, in some embodiments of the present disclosure substantially solids, colorant, and/or metals free, may be directed to the recovery steps previously described for FIG. 1A. Thus, in the absence of any additional purifying steps, a third intermediate mixture 164 illustrated in FIG. 1B may be equivalent to the first mixture 115 illustrated in FIG. 1A. FIG. 2 illustrates an embodiment of a system for achieving the method illustrated in FIGS. 1A and 1B and described above.

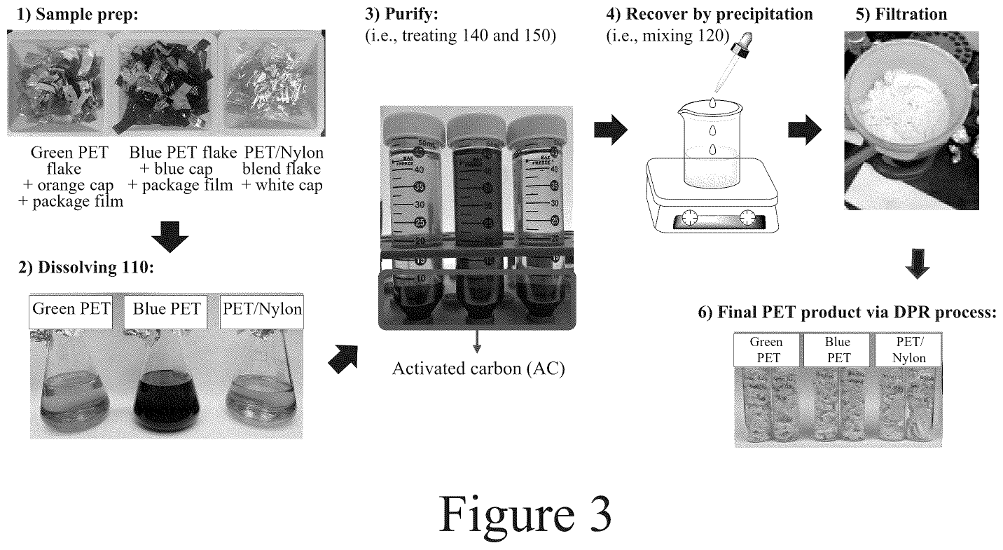

FIG. 3 illustrates photographs of three different samples of PET derived from bottles that were treated according to the method described above. Panel 1) illustrates the PET samples that were tested: one sample of PET was colored with a green colorant, a second PET sample was colored with a blue colorant, and third was uncolored PET but contained Nylon 6,6 as a contaminant (Nylon-MXD6, which is produced from m-xylenediamine (MXDA)). In addition, each of the three PET samples included PET from bottle caps, an orange cap, a blue cap, and white cap, respectively. Further, both of the green PET and blue PET also contained package film. The packaging film was made of PP and/or PVC and the cap materials of PE. The caps were sometimes colored. Both caps and packaging films generally contained less than 1-2 wt % of PET. The form of each PET sample was flakes having an average length between 5 mm and 20 mm and an average thickness between 0.25 mm and 0.89 mm.

Referring to Panel 2) of FIG. 3, each of the three PET samples was individually dissolved (i.e., in a dissolving 110 step) in 2-IPP (i.e., solvent 107). Dissolution conditions were maintained at a temperature of about 160° C. for a period of time between 10 minutes and 30 minutes. The resultant first mixture 115 was then subjected to a first treating 140, where the first mixture 115 was filtered to remove insoluble solids, thereby forming a solids-free or substantially solids-free first intermediate mixture 144. The resultant filtered first intermediate mixture 144 is illustrated in Panel 2) of FIG. 3. Referring to Panel 3), next the filtered first intermediate mixture 144 was treated with an activated carbon (corresponding to a second treating 150) to form a second intermediate mixture 154. The mixture resulting from the contacting with activated carbon is illustrated in Panel 3) of FIG. 3. The second treating 150 of the first intermediate mixture 144 with activated carbon was performed by mixing the first intermediate mixture 144 with activated carbon having a 20-60 mesh size on a shaker (200-400 rpm) at room temperature for about 16 hours. Panel 3) of FIG. 3 shows that the particular activated carbon and process conditions were not particularly effective at removing the colorant, although adsorption to remove colorant may be successful using different solid adsorbents and/or process conditions.

For example, colorant removal may be improved by the use of ultrasound to improve the interfacial interactions between a solid adsorbent (e.g., activated carbon) and a first intermediate mixture 144. In some embodiments of the present disclosure, a polymeric adsorbent resin (e.g., Amberlite XDA16, an unfunctionalized crosslinked polystyrene-divinylbenzene resin and/or Amberlite XAP7HP, an unfunctionalized crosslinked aliphatic acrylic resin) may be used to remove colorant. Panel 4) of FIG. 3 illustrates the mixing 120 step of the first mixture 115 (i.e., the second intermediate mixture 154) with a precipitant 118 (e.g., acetic acid) to from a second mixture 123 that included the precipitated solid PET in a liquid phase of solvent 107, precipitant 118, and colorant. In this example of mixing 120 a solvent 107 with a first mixture 115, the first mixture 115 of a PET solution was added dropwise to the solvent, in this case between 60 vol % and 100 vol % acetic acid in water. This mixing of the solvent with the PET solution was completed with mechanical stirring, resulting the precipitation of the polymer as a solid. Panel 5) of FIG. 3 illustrates a final treating 130 of second mixture 123 by filtration resulting in a solid product 132 of PET shown in Panel 6). These photographs show that the final PET products 132 were substantially colorless, e.g., white, for each of the three starting samples of PET that were tested, green PET, blue PET, and colorless PET blended with Nylon-MXD6 (a semi-aromatic polyamide derived from the polycondensation of meta-xylene diamine (MXDA) with adipic acid (hexanedioic acid)). Nylon remained in the final product as illustrated in Panel 6 of FIG. 3.

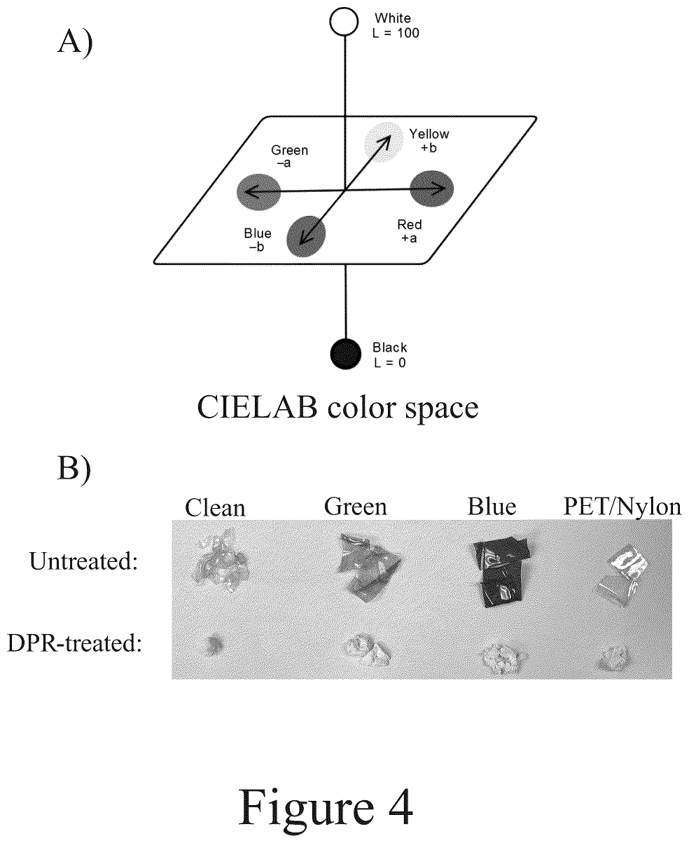

FIG. 4 illustrates quantitative measurements of color of each of the three starting PET samples (post-treating, untreated) (green, blue, colorless PET/nylon) as well as “clean” PET versus the same materials after treatment using the methods described herein (DPR-treated; Dissolve, Purify, Recover). Color levels were measured using an UltraScan VIS (spectrophotometer) from Hunter Lab. The metrics for measuring color are shown in Panel A of FIG. 4 and the actual measured values are tabulated below in Table 1. Photographs of each sample are also shown in Panel B of FIG. 4. Both the spectroscopic measurements and the photographs illustrate that the methods described herein are very effective at removing colorants from both PET and nylon-containing PET to produce substantially colorless PET and nylon-containing PET. These data show that individual colorants can be successfully removed, e.g., blue or green. However, it is anticipated that mixtures of starting PET having two or more colorants may be treated simultaneously using the methods described herein.

TABLE 1
Color Level Measurement Results

| | | L* | A* | B* | |
|---|---|---|---|---|---|
| | Sample | (lightness) | (+red/−green) | (+yellow/−blue) | dE* |
| | White | 99.41 | −0.22 | 0.16 | — |
| Untreated | Clean PET | 85.14 | −0.26 | 0.29 | 14.27 |
| | Green PET | 82.67 | −28.91 | 21.01 | 39.21 |
| | Blue PET | 53.35 | −9 | −49.32 | 68.17 |
| | PET/Nylon | 88.72 | −1.79 | 1.48 | 10.88 |
| DPR- | Clean PET | 91.28 | −0.1 | 3.43 | 8.76 |
| treated | Green PET | 95.29 | −0.78 | −0.89 | 4.19 |
| | Blue PET | 96.57 | −0.69 | −0.36 | 2.92 |
| | PET/Nylon | 95.25 | 0.01 | 0.2 | 4.16 |

dE*: Color deviation from standard - smaller value are better

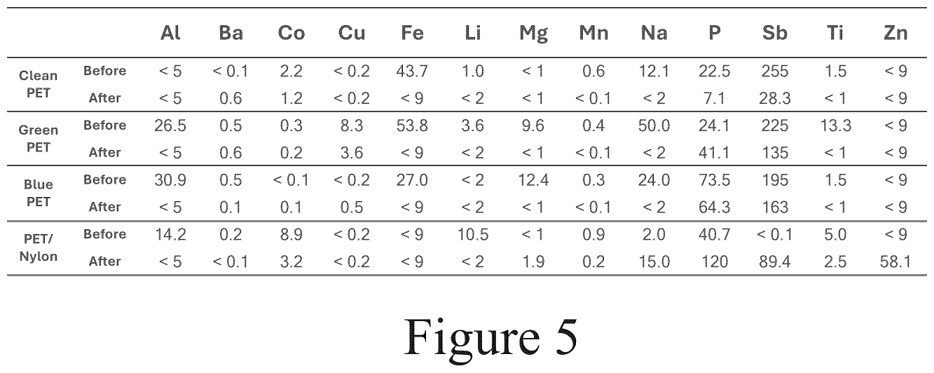

FIG. 5 illustrates ICP-MS results obtained of the precipitated PET solids after the DPR processes for clear PET, green PET, blue PET, and PET/nylon. Values preceded with “<” indicated the methods described herein were effective at removing those metals to at or below the detection limits of the ICP-MS method used. These results show that the methods described herein can be very effective at removing at least some soluble metals; e.g., Al, Ba, Co, Cu, Fe, Li, Mg, Mn, Na, P, Sb, Ge, Ti, and/or Zn. Some of the ICP-MS results are erroneous, e.g., the PET/nylon sample, as indicated by the increase in Na, P, Sb, and Zn concentrations after treatment. These erroneous results may be due to inadvertent errors introduced during the ICP-MS analysis. Among other benefits, the purified PET is expected to prevent discoloration and degradation of PET during melt process for mechanical recycling.

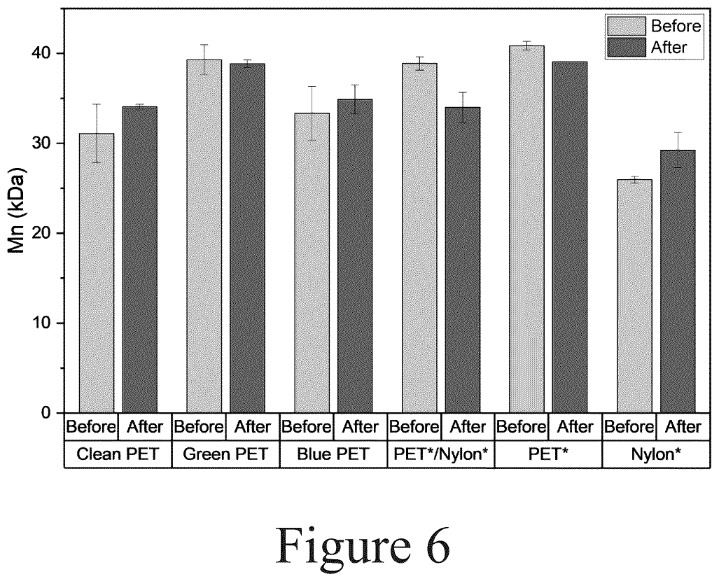

FIG. 6 illustrates molecular weight data for the three samples previously illustrated in FIGS. 3-5 and described above. In summary, these data show that the method for removing colorant from colored PET has no or negligible effects on the molecular weights of the recovered PET compared to the starting values before treatment. The bar chart in FIG. 6 illustrates that the number average molecular weight (Mn) remained essentially the same before and after treatment within the experimental error of measurement. All samples were measured in duplicate. The values summarized in Table 2 below show that both the weight average molecular weight (Mw) and polydispersity (PDI) remained essentially unchanged after treatment. (The “PET*Nylon*” sample the same as the “PET/Nylon” sample described in the previous figures. PET* is the PET layer separated from the PET/nylon sample and Nylon* is the nylon layer separated from the PET/nylon sample.)

TABLE 2
Summary of GPC Data

| | Sample | Mn (kDa) | Mw (kDa) | PDI |
|---|---|---|---|---|
| Untreated | Clean PET | 31.09 | 40.41 | 1.30 |
| | Green PET | 39.30 | 50.30 | 1.28 |
| | Blue PET | 33.33 | 42.64 | 1.28 |
| | PET*/Nylon* | 38.88 | 51.16 | 1.32 |
| | PET* | 40.85 | 53.18 | 1.30 |
| | Nylon* | 25.96 | 35.70 | 1.38 |
| DPR- | Clean PET | 34.06 | 43.60 | 1.28 |
| Treated | Green PET | 38.84 | 49.88 | 1.28 |
| | Blue PET | 34.88 | 44.96 | 1.29 |
| | PET*/Nylon* | 33.99 | 44.69 | 1.32 |
| | PET* | 39.08 | 50.16 | 1.28 |
| | Nylon* | 29.25 | 38.99 | 1.33 |

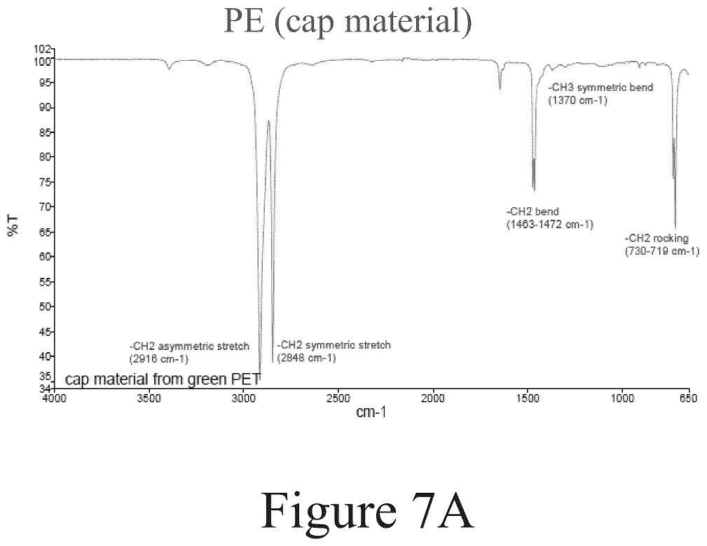

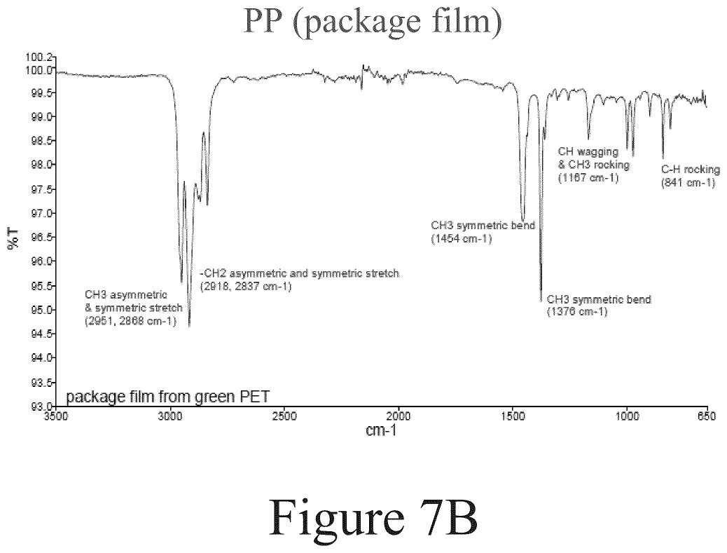

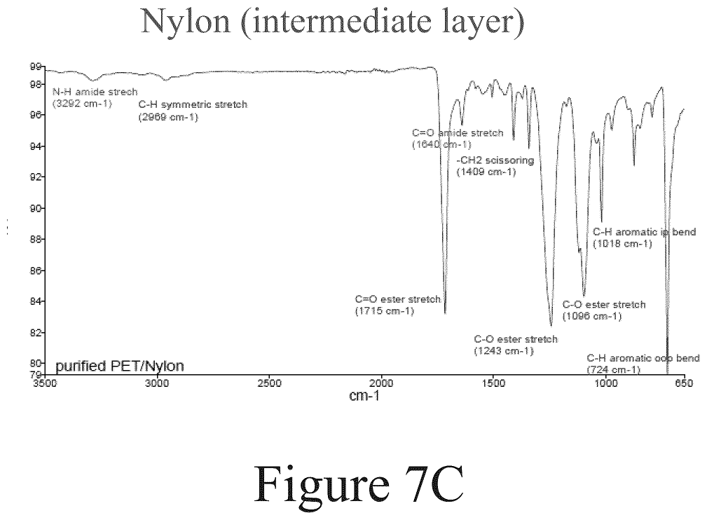

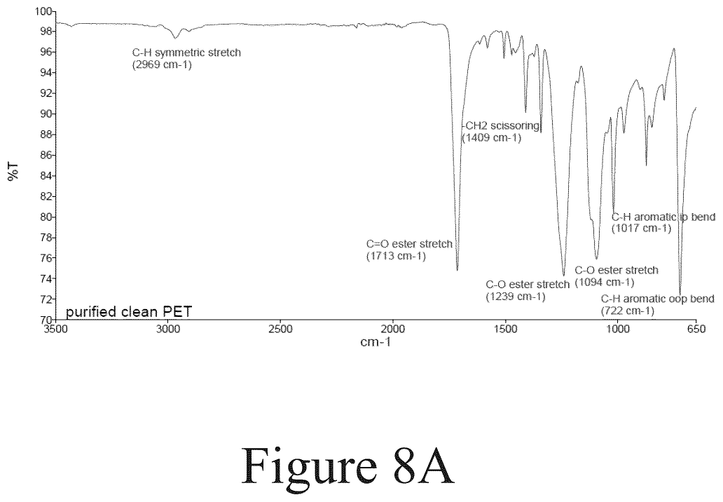

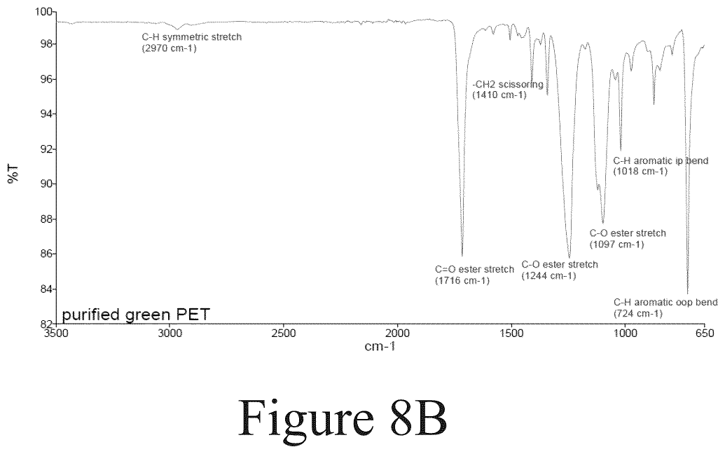

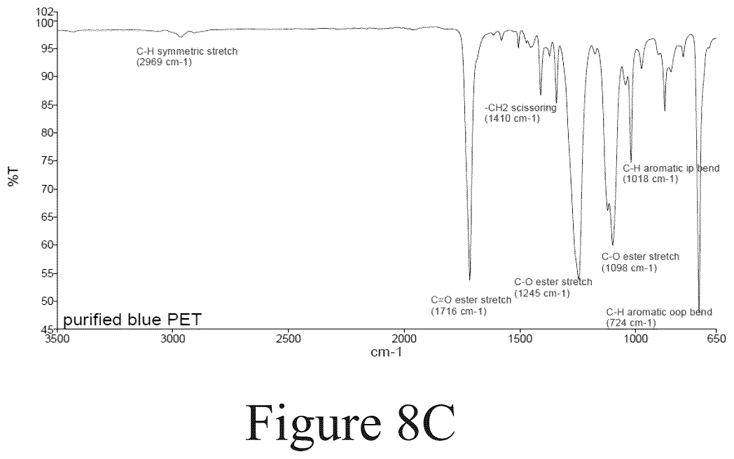

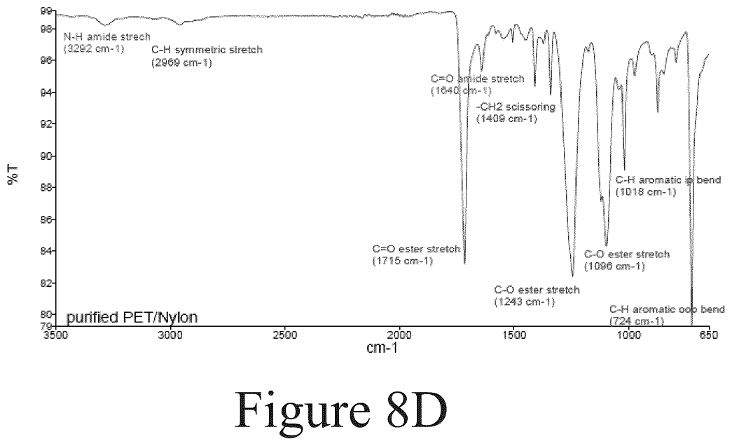

By Fourier-transform infrared spectroscopy (FTIR) analysis, FIGS. 7A-7C demonstrate the presence of polymeric materials (PE, PP, and nylon) other than PET within the PET bottle samples. FIGS. 8A-8D indicate that the purified PET product after the DPR processes contains no PE or PP. However, the purified PET/nylon sample contains both PET and nylon, suggesting that nylon remains after the DPR processes.

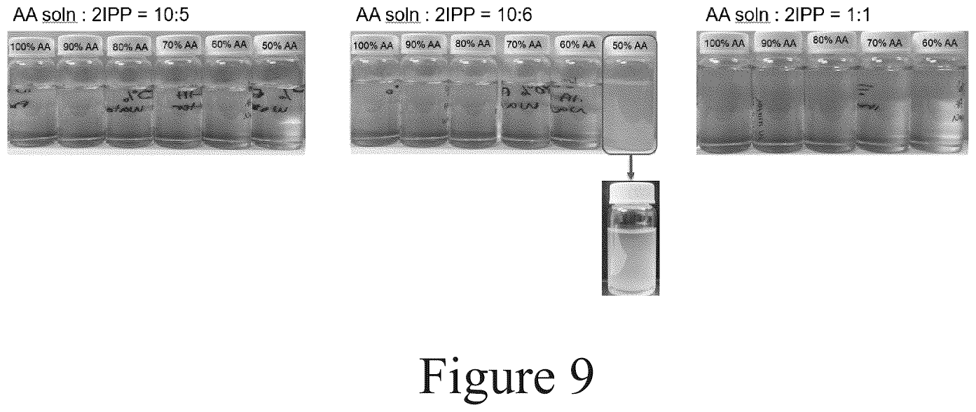

FIG. 9 summarizes solubility data for a system including each of acetic acid, water, and 2-IPP. These data show that acetic acid in water solutions from 100 vol % acetic acid to 60% acetic acid, 2-IPP is completely soluble in the acetic acid solutions for volumetric ratios of acetic acid solution to 2-IPP from 1:1 to 10:1. However, once the acetic acid concentration in water drops to 50%, 2-IPP is insoluble in the acetic acid solutions when the volumetric ratio of acetic acid solution to 2-IPP is below 10:5. These data suggest that the optimum starting concentration of a solution for precipitating PET will be a solution of acetic acid in water at a concentration of acetic acid of greater than 50% and that this solution is best added to a mixture of dissolved PET in 2-IPP at a ratio of acetic acid solution to 2-IPP between 1:1 and 10:1.

The following illustrates another example for obtaining PET. In this example, an antisolvent solution was prepared by mixing 85 vol % acetic acid with 15 vol % 2-isopropyl phenol (2-IPP) in a container using an overhead mechanical stirrer, and the antisolvent solution was maintained at room temperature. A solution of PET (5-10 wt %) in 2-IPP was then gradually transferred into the antisolvent solution via a peristaltic pump at a speed of 80-100 rpm. As the PET solution was introduced, it dispersed and integrated with the antisolvent solution, resulting in the precipitation of PET powder.

This antisolvent solution also acted as good solvent for the colorants that were present in the PET, which facilitated the partial removal of color from the PET during the precipitation process. The colorants were dissolved and dispersed within the liquid phase, thereby enabling their extraction. The PET precipitate was subsequently recovered by filtration and drying of the PET filter cake.

### EXAMPLES

Example 1. A method comprising: dissolving a solid comprising a colorant and polyethylene terephthalate (PET) in 2-isopropylphenol (2-IPP) to form a first mixture; and mixing the first mixture with an acetic acid solution to form a second mixture comprising a solid phase and a liquid phase, wherein: the acetic acid solution comprises acetic acid and at least one of water or a solvent with the acetic acid present at a concentration between 60 vol % and 100 vol %, inclusively, the solid phase comprises at least one of a substantially colorant-free PET or a colorant-free PET, or a combination thereof, and the liquid phase comprises acetic acid, 2-IPP, and the colorant.

Example 2. The method of Example 1, wherein the solvent is present in the acetic acid solution at a concentration between 1 vol % and 40 vol %.

Example 3. The method of either Example 1 and/or Example 2, wherein the solvent comprises 2-IPP.

Example 4. The method of any one of Examples 1-3 wherein the liquid phase further comprises water.

Example 5. The method of any one of Examples 1-4, wherein, during the mixing, the acetic acid solution results in the second mixture having a volumetric ratio of acetic acid solution to 2-IPP between 1:1 and 10:1.

Example 6. The method of any one of Examples 1-5, wherein the colorant comprises at least one of a pigment or a dye or a combination thereof.

Example 7. The method of any one of Examples 1-6, wherein the dissolving is performed using a concentration of PET between 1 wt % and 50 wt % PET or between 5 wt % and 10 wt % PET relative to the total mass of the first mixture.

Example 8. The method of any one of Examples 1-7, wherein the dissolving is performed at a temperature between 21° C. and 200° C. or between 100° C. and 160° C.

Example 9. The method of any one of Examples 1-8, wherein the dissolving is performed at approximately atmospheric pressure.

Example 10. The method of any one of Examples 1-9, wherein the dissolving is performed by contacting the PET and the 2-IPP for period of time between 1 minute and 4 hours or between 10 minutes and 30 minutes.

Example 11. The method of any one of Examples 1-10, wherein the mixing is performed at temperature between 0° C. and 100° C. or between 0° C. and 50° C.

Example 12. The method of any one of Examples 1-11, wherein the mixing is performed at approximately atmospheric pressure.

Example 13. The method of any one of Examples 1-12, wherein the mixing is performed by contacting the acetic acid solution and the first mixture for a period of time between 1 minute and 4 hours or between 10 minutes and 30 minutes.

Example 14. The method of any one of Examples 1-13, wherein the solid further comprises a contaminant comprising at least one of a metal, a plastic, a plastic additive, an organic contaminant, an inorganic contaminant, or a combination thereof.

Example 15. The method of any one of Examples 1-14, wherein the plastic comprises at least one of polyethylene (PE), polypropylene (PP), polyvinyl chloride (PVC), or a combination thereof.

Example 16. The method of any one of Examples 1-15, wherein the metal comprises at least one of Al, Ba, Co, Cu, Fe, Li, Mg, Mn, Na, P, Sb, Ge, Ti, Zn, or a combination thereof.

Example 17. The method of any one of Examples 1-16, wherein the metal dissolves in the first mixture.

Example 18. The method of any one of Examples 1-17, wherein the metal comprises metal particles.

Example 19. The method of any one of Examples 1-18, wherein the plastic additives comprises at least one of an anti-oxidant, a thermal stabilizer, a nucleating agent, a catalyst, a processing aid, a plasticizer, or a combination thereof.

Example 20. The method of any one of Examples 1-19, wherein the organic contaminant comprises at least one of a food waste or dirt or a combination thereof.

Example 21. The method of any one of Examples 1-20, wherein the inorganic contaminant comprises a least one of sand or gravel or a combination thereof.

Example 22. The method of any one of Examples 1-21, further comprising, after the dissolving and before the mixing, a first treating of the first mixture wherein the treating removes at least a portion of at least one contaminant to form a first intermediate first mixture.

Example 23. The method of any one of Examples 1-22, wherein the contaminant removed includes at least one of dirt, sand, gravel, metal particles, or a combination thereof.

Example 24. The method of any one of Examples 1-23, wherein the first treating is performed by at least one of gravity settling, filtration, centrifugation, or a combination thereof.

Example 25. The method of any one of Examples 1-24, wherein the first treating is performed by filtration.

Example 26. The method of any one of Examples 1-25, wherein the filtration is performed using vacuum and a membrane filter having an average pore size of less than or equal to 10 μm.

Example 27. The method of any one of Examples 1-26, wherein the vacuum is less than or equal to 100 mbar.

Example 28. The method of any one of Examples 1-27, further comprising, after the first treating, a second treating of the first intermediate first mixture, wherein the second treating removes at least a portion of the colorant from the first intermediate first mixture to form a second intermediate first mixture.

Example 29. The method of any one of Examples 1-28, wherein the second treating is performed by contacting the first intermediate first mixture with an activated carbon.

Example 30. The method of any one of Examples 1-29, further comprising, after the second treating, a third treating of the second intermediate first mixture, wherein the second treating removes at least a portion of the metal from the second intermediate first mixture to form a third intermediate first mixture.

Example 31. The method of any one of Examples 1-30, wherein the metal is dissolved in the second intermediate first mixture.

Example 32. The method of any one of Examples 1-31, wherein the third treating is performed by contacting the second intermediate first mixture with an ion exchange resin.

Example 33. The method of any one of Examples 1-32, further comprising, after the mixing, a fourth treating of the second mixture, wherein the solid phase is separated from the liquid phase, to yield a substantially pure PET product.

Example 34. The method of any one of Examples 1-33, wherein the fourth treating is performed by at least one of drying, gravity settling, filtration, centrifugation, or a combination thereof.

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
dissolving a solid comprising a colorant and polyethylene terephthalate (PET) in 2-isopropylphenol (2-IPP) to form a first mixture; and
mixing the first mixture with an acetic acid solution to form a second mixture comprising a solid phase and a liquid phase, wherein:
the acetic acid solution comprises acetic acid and at least one of water or a solvent with the acetic acid present at a concentration between 60 vol % and 100 vol %, inclusively,
the solid phase comprises at least one of a substantially colorant-free PET or a colorant-free PET, or a combination thereof, and
the liquid phase comprises acetic acid, 2-IPP, and the colorant.

2. The method of claim 1, wherein the solvent is present in the acetic acid solution at a concentration between 1 vol % and 40 vol %.

3. The method of claim 2, wherein the solvent comprises 2-IPP.

4. The method of claim 1, wherein the liquid phase further comprises water.

5. The method of claim 1, wherein, during the mixing, the acetic acid solution results in the second mixture having a volumetric ratio of acetic acid solution to 2-IPP between 1:1 and 10:1.

6. The method of claim 1, wherein the colorant comprises at least one of a pigment or a dye or a combination thereof.

7. The method of claim 1, wherein the dissolving is performed using a concentration of PET between 1 wt % and 50 wt % PET relative to the total mass of the first mixture.

8. The method of claim 1, wherein the solid further comprises a contaminant comprising at least one of a metal, a plastic, a plastic additive, an organic contaminant, an inorganic contaminant, or a combination thereof.

9. The method of claim 8, wherein the plastic comprises at least one of polyethylene (PE), polypropylene (PP), polyvinyl chloride (PVC), or a combination thereof.

10. The method of claim 8, wherein the metal comprises at least one of Al, Ba, Co, Cu, Fe, Li, Mg, Mn, Na, P, Sb, Ge, Ti, Zn, or a combination thereof.

11. The method of claim 8, further comprising, after the dissolving and before the mixing, a first treating of the first mixture wherein the treating removes at least a portion of at least one contaminant to form a first intermediate first mixture.

12. The method of claim 11, wherein the contaminant removed includes at least one of dirt, sand, gravel, metal particles, or a combination thereof.

13. The method of claim 11, wherein the first treating is performed by at least one of gravity settling, filtration, centrifugation, or a combination thereof.

14. The method of claim 11, further comprising, after the first treating, a second treating of the first intermediate first mixture, wherein the second treating removes at least a portion of the colorant from the first intermediate first mixture to form a second intermediate first mixture.

15. The method of claim 14, wherein the second treating is performed by contacting the first intermediate first mixture with an activated carbon.

16. The method of claim 14, further comprising, after the second treating, a third treating of the second intermediate first mixture, wherein the second treating removes at least a portion of the metal from the second intermediate first mixture to form a third intermediate first mixture.

17. The method of claim 16, wherein the third treating is performed by contacting the second intermediate first mixture with an ion exchange resin.

18. The method of claim 1, further comprising, after the mixing, a fourth treating of the second mixture, wherein the solid phase is separated from the liquid phase, to yield a substantially pure PET product.

19. The method of claim 18, wherein the fourth treating is performed by at least one of drying, gravity settling, filtration, centrifugation, or a combination thereof.
